(19) United States
(12) Patent Application Publication
(10) Pub. No.: US 2005/0100224 A1
(43) Pub. Date: May 12, 2005

(54) Transcoding of digital data

(75) Inventors: Felix Henry, Rennes (FR); Ioana Donescu, Rennes (FR); Guillaume Fuchs, Ergue Gaberic (FR)

Correspondence Address: FITZPATRICK CELLA HARPER & SCINTO, 30 ROCKEFELLER PLAZA, NEW YORK, NY, 10112, US

(73) Assignee: CANNON KABUSHIKI KAISHA, Tokyo (JP)

(21) Appl. No.: 10/668,389

(22) Filed: Sep. 24, 2003

(30) Foreign Application Priority Data
Sep. 25, 2002 (FR) 0211844

(51) Int. Cl. G06K 9/36

(52) U.S. Cl. 382/232

(57) ABSTRACT

A method of transcoding digital data coded according to a first coding mode into digital data coded according to a second coding mode. The method includes detecting the inactivity of resources useful for the transcoding, and transcoding the digital data coded according to the first coding mode into the digital data coded according to the second coding mode, when the inactivity is detected.

The present invention concerns in general terms digital signal coding.

The purpose of coding is to compress the signal, which makes it possible to transmit or respectively store the digital signal by reducing the transmission time or the transmission rate, or respectively by reducing the memory space used.

More precisely, the invention concerns the transcoding of a digital signal coded according to a first coding mode into a digital signal coded according to a second coding mode, the second coding mode making it possible to form coded data files of reduced size.

Hereinafter the digital signal considered is a digital image, the first coding mode is a coding in accordance with the JPEG (from the English Joint Photographic Expert Group) standard or a coding according to the JPEG2000 standard.

Compressed images generally occupy a large memory size, which is disadvantageous for example for digital photographic apparatus. In such an apparatus, a memory card can store only approximately thirty images. The user must therefore purchase an additional card if he wishes to store a larger number of images.

In addition, a large file takes longer to transmit, for example during image exchanges via a network such as the Internet.

The document U.S. Pat. No. 6,298,166 discloses a data transcoding according to which the initial coded data undergo partial decompression and then compression.

The document U.S. Pat. No. 6,288,743 describes the capture of an image in a digital photographic apparatus, the storage of this image in non-compressed form in the memory card of the apparatus and then the compression of the image when the apparatus is inactive.

French patent application No 01 13922 and European patent application No 2 291 286.9 describe coding modes according to which an amplitude model is calculated and a path amongst the coefficients is determined.

The amplitude model supplies an approximation of the amplitude of the coefficients and the path provides an ordered sequence of the locations of the coefficients. The location of the k^{th} coefficient in this series is determined by the path and its amplitude is determined by the ordinate corresponding to the abscissa k according to the amplitude model.

This coding mode makes it possible to obtain coded data files of smaller size, but the format is not conventional and can be decoded only by a dedicated decoder.

The present invention aims to remedy the drawbacks of the prior art by providing a transcoding method and device which make it possible to obtain coded data files of smaller size whilst being able to be decoded by a conventional decoder.

To this end, the invention proposes a method of transcoding digital data coded according to a first coding mode into digital data coded according to a second coding mode,
characterized in that it includes the steps of:
   detecting the inactivity of resources useful for the transcoding,
   transcoding the digital data coded according to the first coding mode into the digital data coded according to the second coding mode, when the inactivity is detected.

The invention makes it possible to obtain coded data files of smaller size whilst being able to be decoded by a conventional decoder. Thus more files can be stored in memory and the user does not have to be concerned with the fact that these files are coded according to a non-conventional coding mode.

According to a preferred characteristic, the method also includes the steps of:
detecting a request demanding data coded according to the first coding mode,
verifying that the data demanded are coded according to the second coding mode,
transcoding the data coded according to the second coding mode into data coded according to the first coding mode, if the response at the verification step is positive.

The functioning of the method is thus transparent for the user.

According to a preferred characteristic, the method also includes the step of:
selecting an order of transcoding of the digital data coded according to the first coding mode into the digital data coded according to the second coding mode.

According to preferred alternative characteristics, the transcoding order is determined according to the size of the files containing the data to be transcoded or the transcoding order is determined according to the frequency of demand for the files containing the data to be transcoded.

According to preferred alternative characteristics, the first coding mode is a coding according to the JPEG standard or according to the JPEG2000 standard. These coding modes are very widespread and it is therefore advantageous to use them.

According to a preferred characteristic, the second coding mode is a coding according to which the data are coded by an amplitude curve and a path amongst the data. This type of coding provides more compact coded files than within the coding modes such as JPEG or JPEG2000.

According to a preferred characteristic, the data are a digital image. This is because the invention applies particularly to images, which traditionally require a large amount of space in memory to store them.

Correspondingly, the invention concerns a device for transcoding digital data coded according to a first coding mode into digital data coded according to a second coding mode,
characterized in that it comprises:
   means of detecting the inactivity of resources useful for the transcoding,
   means of transcoding the digital data coded according to the first coding mode into the digital data coded according to the second coding mode, when the inactivity is detected.

The transcoding device comprises means of implementing the above characteristics and has advantages similar to those presented previously.

The invention also concerns a digital apparatus including the device according to the invention or means of implementing the method according to the invention. This digital apparatus is for example a digital photographic apparatus, a digital camcorder, a scanner, a printer, a photocopier or a facsimile machine. The advantages of the device and of the digital apparatus are identical to those disclosed above.

The invention also concerns an information storage means which can be read by a computer or by a microprocessor, integrated or not into the device, possibly removable, stores a program implementing the method according to the invention.

The invention also concerns a computer program which can be read by a microprocessor and containing one or more sequences of instructions is able to implement the methods according to the invention.

The characteristics and advantages of the present invention will emerge more clearly from a reading of a preferred embodiment illustrated by the accompanying drawings, in which:

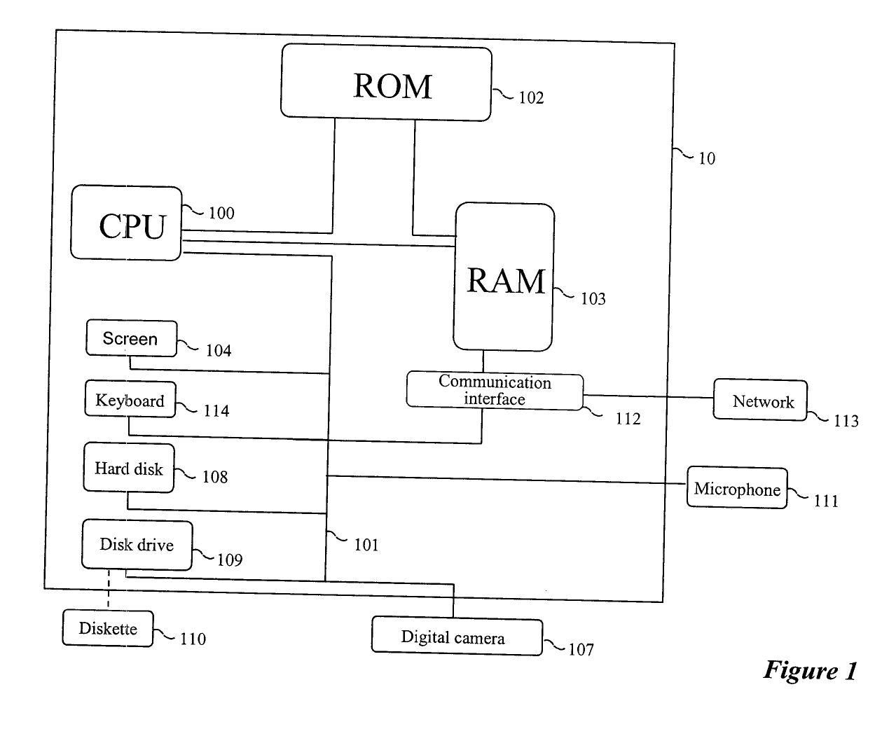

FIG. 1 depicts an embodiment of a device implementing the invention,

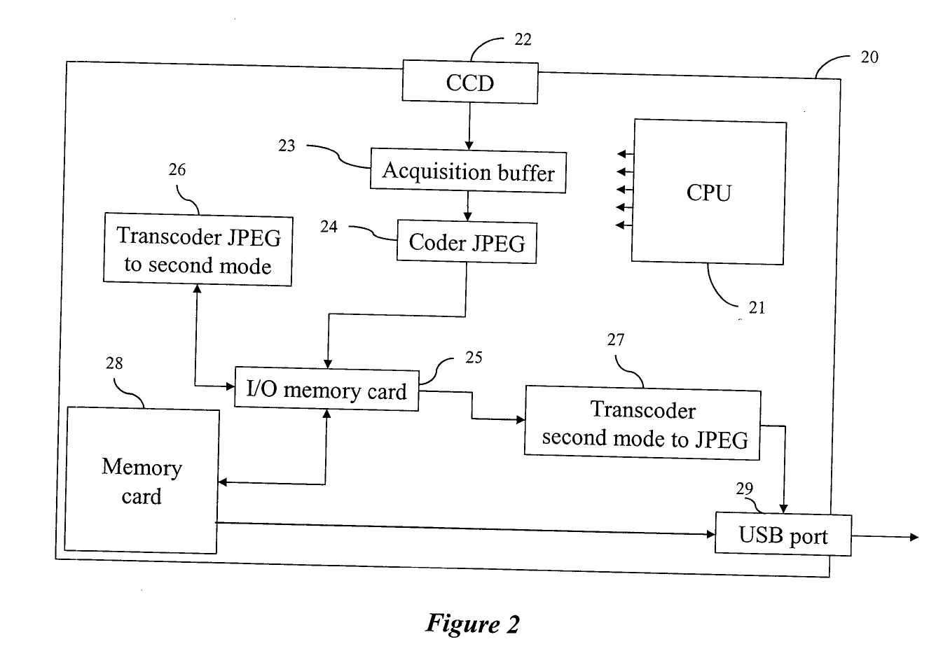

FIG. 2 depicts an embodiment of a device implementing the invention,

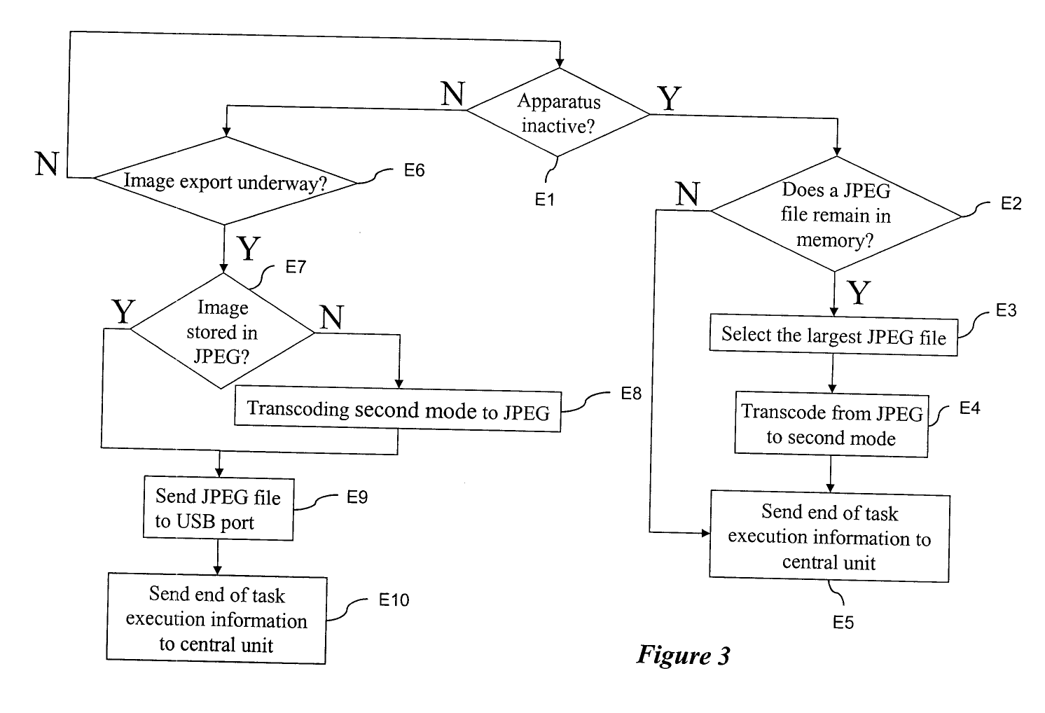

FIG. 3 depicts a first embodiment of a transcoding method according to the invention,

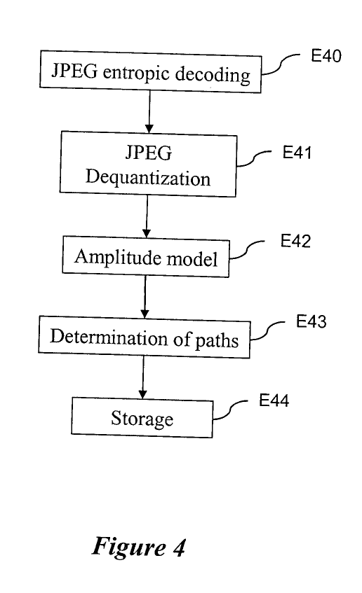

FIG. 4 depicts a transcoding according to the invention,

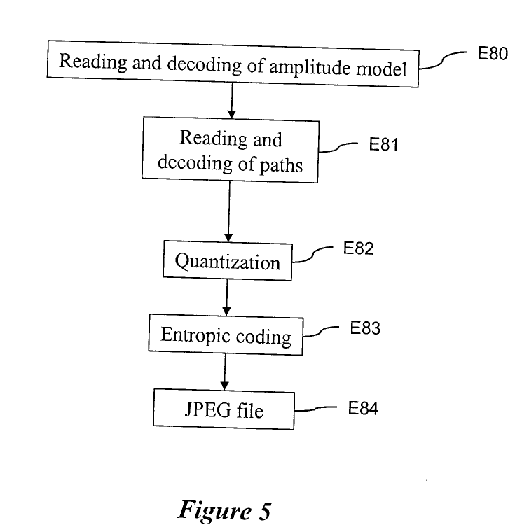

FIG. 5 depicts a transcoding according to the invention,

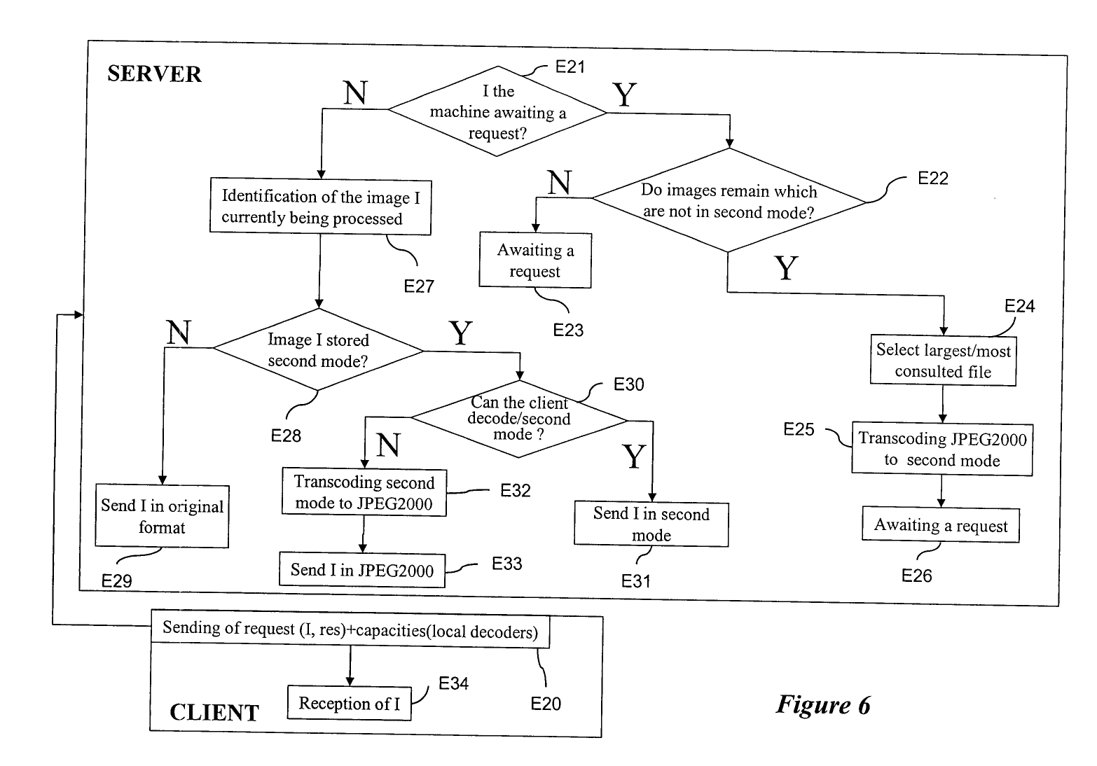

FIG. 6 depicts a second embodiment of a transcoding method according to the invention,

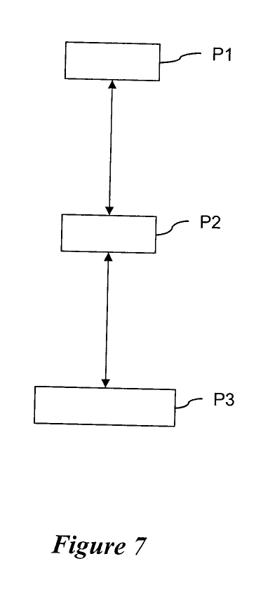

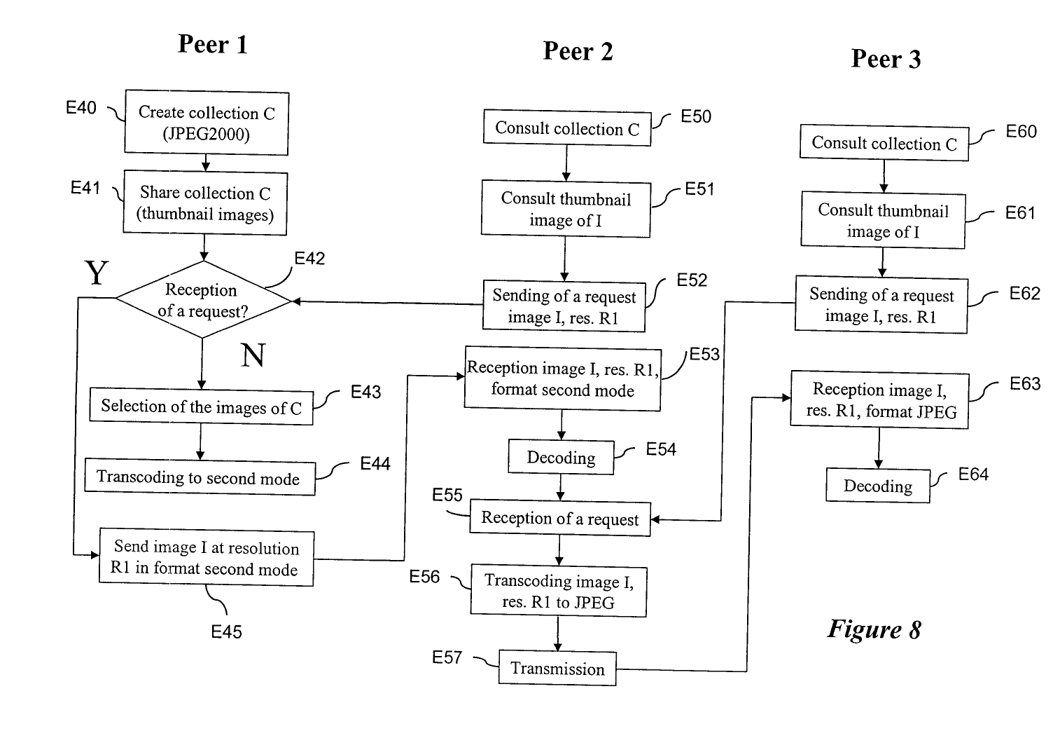

FIGS. 7 and 8 depict a third embodiment of a transcoding method according to the invention.

According to the chosen embodiment depicted in FIG. 1, a device implementing the invention is for example a microcomputer 10 connected to various peripherals, for example a digital camera 107 (or a scanner, or any image acquisition or storage means) connected to a graphics card and supplying information to be processed according to the invention.

The device 10 comprises a communication interface 112 connected to a network 113 able to transmit digital data to be processed or conversely to transmit data processed by the device. The device 10 also comprises a storage means 108 such as for example a hard disk. It also comprises a drive 109 for a disk 110. This disk 110 can be a diskette, a CD-ROM or a DVD-ROM for example. The disk 110, like the disk 108, can contain data processed according to the invention as well as the program or programs implementing the invention which, once read by the device 10, will be stored in the hard disk 108. According to a variant, the program enabling the device to implement the invention can be stored in read only memory 102 (referred to as ROM in the drawing). In a second variant, the program can be received in order to be stored in an identical fashion to that described above by means of the communication network 113.

The device 10 is connected to a microphone 111. The data to be processed according to the invention will in this case be of the audio signal.

This same device has a screen 104 for displaying the data to be processed or serving as an interface with the user, who can thus parameterize certain processing modes, by means of the keyboard 114 or any other means (a mouse for example).

The central unit 100 (referred to as CPU in the drawing) executes the instructions relating to the implementation of the invention, instructions stored in the read only memory 102 or in the other storage elements. On powering up, the processing programs stored in a non-volatile memory, for example the ROM 102, are transferred into the random access memory RAM 103, which will then contain the executable code of the invention as well as registers for storing the variables necessary for implementing the invention.

In more general terms, an information storage means, which can be read by a computer or by a microprocessor, integrated or not into the device, possibly removable, stores a program implementing the method according to the invention.

The communication bus 101 allows communication between the various elements included in the microcomputer 10 or connected to it. The representation of the bus 101 is not limiting and in particular the central unit 100 is able to communicate instructions to any element of the microcomputer 10 directly or by means of another element of the microcomputer 10.

With reference to FIG. 2, one embodiment of the invention is a digital photographic apparatus 20.

The device according to the invention comprises a central unit 21 which controls the other elements of the photographic apparatus and executes the instructions relating to the implementation of the invention.

A CCD sensor 22 captures an image. It is connected to an acquisition buffer 23, itself connected to a JPEG coder 24.

A memory card 25 is connected to the JPEG coder 24, to a first JPEG transcoder to a second coding mode 26, a second transcoder from the second coding mode to the JPEG mode 27 and to a memory card 28.

The transcoder 27 and the memory card 28 are connected to a USB port which makes it possible to transmit data to another apparatus, such as a computer.

According to the invention, the device comprises:
means 21 of detecting the inactivity of resources useful for the transcoding,
means 26 of transcoding the digital data coded according to the first coding mode into the digital data coded according to the second coding mode, when the inactivity is detected.

The functioning of the device and in particular of the transcoders which are objects of the invention will be detailed hereinafter.

FIG. 3 depicts an embodiment of an image transcoding method according to the invention. This method is implemented in the digital photographic apparatus described above and comprises steps E1 to E10.

The method is performed in the form of an algorithm, which can be stored in whole or in part in any information storage means capable of cooperating with the microprocessor. This storage means can be read by a computer or by a microprocessor. This storage means is integrated or not into the device, and may be removable.

Step E1 is a test for verifying whether the apparatus is inactive. For this purpose, the central unit 21 detects at regular intervals of time, for example every 2 seconds, the active or inactive state of the processing elements of the apparatus. When the central unit 21 sends a task execution instruction to a unit of the apparatus, the unit in question is considered to be active as long as it has not sent end of task execution information to the central unit. The central unit then detects that the apparatus is inactive when no unit is active.

If the state of the elements is inactive, then this step is followed by step E2, which is a test for determining whether there is at least one file to the JPEG format in memory 28.

If the response is positive, then step E2 is followed by step E3, at which a JPEG file is selected. The selection is made according to a predetermined criterion, for example according to the size of the files stored.

The largest file is then selected, which makes it possible to gain the most space in memory.

The following step E4 is the transcoding of the JPEG file previously selected.

This step is detailed below. It results in a file containing the image coded according to a second coding mode. This file is of reduced size compared with the corresponding JPEG file.

If the response is negative at step E2, this means that there is no JPEG file to be transcoded. This step is then followed by step E5.

Likewise, step E4 is followed by step E5, which is a sending of an end of task execution information to the central unit.

If the response is negative at step E1, then this step is followed by step E6, which is a test for determining whether an image is currently being exported from the memory card 28 to another apparatus, via the USB port.

If the response is negative, then step E6 is followed by the previously described step E1.

When the response is positive at step E6, then this step is followed by step E7, which is a test for determining whether the image currently being exported is to the JPEG format.

If the response is negative, then this step is followed by step E8, which is a transcoding of the image currently being exported, from the second coding mode to the JPEG format.

This step will be detailed below.

Step E8 is followed by step E9, which is the transfer of the image coded according to the JPEG mode to the USB port 29 of the photographic apparatus.

When the response is positive at step E7, then the image to be transmitted is coded to the JPEG format. Step E7 is then followed by step E9.

Step E9 is followed by step E10, which is a sending of an end of task execution information to the central unit.

FIG. 4 shows the transcoding of an image coded according to the JPEG coding mode into an image coded according to a second coding mode (step E4).

The second coding mode is the coding mode described in French patent application No 01 13922. This coding mode comprises the calculation of an amplitude model and the determination of a path amongst the coefficients. The amplitude model supplies an approximation of the amplitude of the coefficients and the path supplies an ordered series of the locations of the coefficients. The location of the k^{th} coefficient in this series is determined by the path and its amplitude is determined by the ordinate corresponding to the abscissa k according to the amplitude model.

In more general terms, the second coding mode is one of the coding modes described in European patent application No 2 291 286.9.

The transcoding comprises steps E40 to E44.

Step E40 is an entropic decoding of the data contained in the JPEG file.

The following step E41 is a dequantization of the entropically decoded data. The result is a set of DCT data blocks.

The following step E42 is the determination and coding of an amplitude model for each block.

The following step E43 is the determination and coding of a coefficient path for each block.

The following step E44 is the formation of a file containing the image coded according to the second coding mode. This file is stored on the memory card in place of the original JPEG file.

The file coded according to the second coding mode occupies a memory size approximately 15 to 20% smaller than the corresponding JPEG file.

FIG. 5 shows the transcoding of an image coded according to the second coding mode into an image coded according to the JPEG coding mode (step E8).

The transcoding is substantially the reverse of the previously described transcoding and comprises steps E80 to E84.

Step E80 is the reading and decoding of the amplitude model for each block.

The following step E81 is the reading and decoding of the coefficient path for each block. The result is a set of DCT data blocks.

The following step E82 is a quantization of the data according to the JPEG mode.

The following step E83 is an entropic coding of the quantized data.

The following step E84 is the formation of a file containing the image coded according to the JPEG coding mode.

A second embodiment of the invention is described with reference to FIG. 6. This is a client-server application. A client computer communicates with a server computer, via a data transmission network known per se.

Overall, according to the invention, a test is carried out in the server. If the server is not in the process of processing a request, it transcodes the images from the JPEG2000 coding mode to a second mode according to which the coded data occupy less space in memory. The second mode is identical to that described in the first embodiment.

When the server processes a request, it performs a transcoding from the second coding mode to JPEG2000, when necessary.

Step E20 is the sending of a request from the client to the server.

This request comprises the identification of the image requested, its resolution and the decoding capacity of the client. The decoding capacity comprises in particular the type of decoding which the client can perform.

Step E21 is a test for determining whether the server is in a state of awaiting a request.

When the response is positive, this means that no request has arrived at the server. Step E21 is followed by step E22, which is a test for determining whether there remains at least one image in memory which is not coded according to the second coding mode.

If the response is negative, then step E22 is followed by step E23, during which the server is put in a state of awaiting a request.

When the response is positive at step E22, this step is followed by step E24, at which a JPEG2000 file is selected. The selection is made according to a predetermined criterion, for example according to the size of the files stored. The largest file is then selected, which makes it possible to gain the most space in memory possible. In a variant, the file most frequently requested by clients is selected.

The following step E25 is the transcoding of the previously selected JPEG2000 file.

This step is similar to the previously described step E4. It results in a file containing the image coded according to a second coding mode.

At the following step E26, the server is put in a state of awaiting a request.

When the response is negative at step E21, this means that a request is currently being processed by the server. Step E21 is followed by step E27, which is an identification of the image currently being processed.

Step E27 is followed by step E28, which is a test for determining whether the image requested is stored in coded form according to the second coding mode.

If the response is negative, this means that the image requested is coded according to the JPEG2000 mode. Step E28 is then followed by step E29, at which the image is transmitted to the client.

If the response is positive at step E28, then this step is followed by step E30, which is a test for determining whether the client can decode an image coded according to the second coding mode.

If the response is positive, then this step is followed by step E31, at which the image coded according to the second coding mode is transmitted to the client. The transmission time is lower than if the image were coded according to the JPEG2000 mode, since the file has a smaller size.

If the response is negative at step E30, this means that the client cannot use an image coded according to the second coding mode. In this case, step E30 is followed by step E32, at which the image coded according to the second coding mode is transcoded to the JPEG2000 format. The transcoding is equivalent to that described previously.

The following step E33 is the transmission of the image coded according to the JPEG2000 coding mode.

After steps E29, E31 and E33, the server is awaiting a request.

In the client computer, step E20 is followed by the step E34 of receiving the image requested.

A third embodiment of the invention is described with reference to FIGS. 7 and 8. This relates to a peer-to-peer architecture. Three user computers are connected to a data transmission network so as to communicate with each other.

The computer P1 is for example a personal computer and is capable of coding and decoding images according to the JPEG2000 coding mode as well as according to the second coding mode. The second coding mode is the one previously described.

The computer P2 is for example a personal computer and is capable of coding images according to the JPEG mode and decoding images according to the second coding mode.

The computer P3 is for example a personal computer of the PDA type and is capable of decoding images according to the JPEG coding mode.

Steps E40 to E45 are implemented in the computer P1, steps E50 to E57 are implemented in the computer P2 and steps E60 to E64 are implemented in the computer P3.

Step E40 is the creation of a collection of images, for example images downloaded from a photographic apparatus. This collection may be shared with the computers P2 and P3.

The following step E41 is the creation of thumbnail images from images in the collection. A thumbnail image is a low-resolution version of an image. For example, for an image of 500×500 pixels, the thumbnail image contains 30×30 pixels. Transmission of the thumbnail image over the network will be very quick.

The following step E42 is a test for determining whether a request is received. In the example depicted, this request comes from the computer P2.

As long as no request is received by the computer P1, step E42 is followed by step E43. During this step, a search is made for the images in the collection which are not coded according to the second coding mode.

If such images exist, step E43 is followed by step E44, which is a transcoding of these images from the JPEG2000 format to the second coding mode. For this purpose, the largest file is first of all selected, or as a variant the one which is most frequently requested by other computers.

Step E50 is a request for consultation of the collection, at the computer P2.

The following step E51 is a request to consult a thumbnail image in the collection.

The following step E52 is the sending of a request to the computer P1 to request the downloading of the image at the resolution of the thumbnail image, and coded according to the second coding mode, since the computer P2 is capable of decoding the data coded according to this coding mode.

When this request is received by the computer P1, step E42 is followed by step E45, at which the image is sent to the computer P2.

At step E53, the computer P2 receives the image, in the form of a thumbnail image coded according to the second coding mode.

The following step E54 is the decoding of the thumbnail image.

Step E60 is a request to consult the collection, at the computer P3.

The following step E61 is a request to consult a thumbnail image in the collection.

The following step E62 is the sending of a request to the computer P2 to request the downloading of the image to the resolution of the thumbnail image, and coded according to JPEG, since the computer P3 is capable of decoding the data coded according to this coding mode.

Step E55 is the reception of this request by the computer P2. The following step E56 is the transcoding of the image from the second coding mode to the JPEG coding mode. The transcoding is similar to that described previously.

The following step E57 is the transmission of the image coded according to the JPEG mode and at the resolution of the thumbnail image.

At step E63, the computer P3 receives the image in the form of a thumbnail image coded according to the JPEG mode.

The following step E64 is the decoding of the thumbnail image.

Naturally the present invention is in no way limited to the embodiments described and depicted, but quite the contrary encompasses any variant within the capability of a person skilled in the art.

1. Method of transcoding digital data coded according to a first coding mode into digital data coded according to a second coding mode,
characterized in that it includes the steps of:
detecting (E1, E21, E42) the inactivity of resources useful for the transcoding,
transcoding (E4, E25, E44) the digital data coded according to the first coding mode into the digital data coded according to the second coding mode, when the inactivity is detected.

2. Method according to claim 1, characterized in that it also comprises the steps of:
detecting (E6, E21) a request demanding data coded according to the first coding mode,
verifying (E7, E28) that the data demanded are coded according to the second coding mode,
transcoding (E8, E32) the data coded according to the second coding mode into data coded according to the first coding mode, if the response at the verification step is positive.

3. Method according to claim 1 or 2, characterized in that it also comprises the step of:
selecting (E3, E24) an order of transcoding of the digital data coded according to the first coding mode into the digital data coded according to the second coding mode.

4. Method according to claim 3, characterized in that the transcoding order is determined according to the size of the files containing the data to be transcoded.

5. Method according to claim 3, characterized in that the transcoding order is determined according to the frequency of requesting the files containing the data to be transcoded.

6. Transcoding method according to claims 1 or 2, characterized in that the first coding mode is a coding according to the JPEG standard.

7. Transcoding method according to claims 1 or 2, characterized in that the first coding mode is a coding according to the JPEG2000 standard.

8. Transcoding method according to claims 1 or 2, characterized in that the second coding mode is a coding according to which the data are coded by an amplitude curve and a path amongst the data.

9. Transcoding method according to claims 1 or 2, characterized in that the data are a digital image.

10. Device for transcoding digital data coded according to a first coding mode into digital data coded according to a second coding mode,
characterized in that it comprises:
means (21) of detecting the inactivity of resources useful for the transcoding,
means (26) of transcoding the digital data coded according to the first coding mode into the digital data coded according to the second coding mode, when the inactivity is detected.

11. Device according to claim 10, characterized in that it also comprises:
means (21) of detecting a request demanding data coded according to the first coding mode,
means (21) of verifying that the data demanded are coded according to the second coding mode,
means (27) of transcoding the data coded according to the second coding mode into data coded according to the first coding mode, if the response at the verification step is positive.

12. Device according to claim 10 or 11, characterized in that it also comprises:
means of selecting an order of transcoding of the digital data coded according to the first coding mode into the digital data coded according to the second coding mode.

13. Device according to claim 12, characterized in that it is adapted to determine the transcoding order according to the size of the files containing the data to be transcoded.

14. Device according to claim 12, characterized in that it is adapted to determine the transcoding order according to the frequency of requesting the files containing the data to be transcoded.

15. Transcoding device according to claims 10 or 11, characterized in that it is adapted to implement a first coding mode, which is a coding according to the JPEG standard.

16. Transcoding device according to claims 10 or 11, characterized in that it is adapted to implement a first coding mode, which is a coding according to the JPEG2000 standard.

17. Transcoding device according to claims 10 or 11, characterized in that it is adapted to implement a second coding mode, which is a coding according to which the data are coded by an amplitude curve and a path amongst the data.

18. Transcoding device according to claims 10 or 11, characterized in that it is adapted to process data which are a digital image.

19. Transcoding device according to claims 10 or 11, characterized in that the detection and transcoding means are incorporated in:
a microprocessor (100),
a read only memory (102) containing a program for processing the data, and
a random access memory (103) containing registers adapted to record variables modified during the execution of said program.

20. Digital data processing apparatus (10), characterized in that it has means adapted to implement the method according to claims 1 or 2.

21. Digital data processing apparatus (10), characterized in that it comprises the device according to claims 10 or 11.

22. Digital data processing apparatus (10) according to claim 20, characterized in that it forms part of a peer-to-peer network.

23. Digital photographic apparatus (20), characterized in that it comprises means adapted to implement the method according to claims 1 or 2.

24. Digital photographic apparatus (20), characterized in that it comprises the device according to claims 10 or 11.

25. Storage medium storing a program for implementing the method according to claims 1 or 2.

26. Storage medium according to claim 25, characterised in that said storage medium is detachably mountable on a device according to claims 10 or 11.

27. Storage medium according to claim 25, characterised in that said storage medium is a floppy disk or a CD-ROM.

28. A computer program on an information carrier, characterized in that it comprises program instructions adapted to implement the method according to claim 1, when this program is loaded and executed in a computer system.
